(19) United States
(12) Patent Application Publication
(10) Pub. No.: US 2015/0191949 A1
(43) Pub. Date: Jul. 9, 2015

(54) Door Barricade

(71) Applicant: Jerry Wilson, Wisconsin Rapids, WI (US)

(72) Inventor: Jerry Wilson, Wisconsin Rapids, WI (US)

(21) Appl. No.: 14/484,063

(22) Filed: Sep. 11, 2014

Related U.S. Application Data
(60) Provisional application No. 61/925,289, filed on Jan. 9, 2014.

(51) Int. Cl. E05C 19/00

(52) U.S. Cl. CPC E05C 19/003

(57) ABSTRACT

Disclosed is a door barricade for use as a home security device that serves to prevent a door from being opened by an intruder. A rigid, elongated bar extends horizontally across a doorway so as to physically prevent the door from opening. The elongated bar includes an L-shaped bracket on each end. Each bracket comprises a first section to be positioned flush against the wall on opposing sides of a doorway, and a second section to which an end of the elongated bar is secured. Bolts can be mounted on opposing sides of a doorway, and the first section of each bracket includes apertures thereon that are capable of receiving the bolts. Once a bolt is inserted through the aperture on the bracket, the shaft of the bolt can be positioned within a narrow channel on the aperture to removably secure the door barricade to the wall.

### CROSS REFERENCE TO RELATED APPLICATION

This application claims the benefit of U.S. Provisional Application No. 61/925,289 filed on Jan. 9, 2014, entitled “Home Protector.” The above identified patent application is herein incorporated by reference in its entirety to provide continuity of disclosure.

### BACKGROUND OF THE INVENTION

1. Field of the Invention

The present invention relates to a door barricade. More specifically, the present invention provides a rigid, elongated bar adapted to be disposed horizontally across a doorway so as to prevent the door from opening, regardless of whether the door is locked. The elongated bar comprises brackets on a first and second end thereof, wherein the brackets can be removably mounted to the wall on opposing sides of the door frame by means of a plurality of bolts mounted on the wall.

Home security is important in order to protect a person's family and possessions. Many doors have one or more locks in order to prevent intruders from gaining access to the house. However, intruders may be able to pick a conventional door lock and gain access to the home even without the appropriate key. Further, some intruders may be able to gain possession of a door key, or can find a key hidden by the home owner. Sometimes home owners may simply forget to lock a door before leaving the home, providing intruders with easy access to the home. Thus, intruders may be able to enter a home despite the fact that a homeowner has locked the door or has taken other similar precautions.

While various home security devices exist for maintaining doors in a closed position, many such devices are unsightly and detract from the appearance of the home and are difficult to install or remove. Many home security devices require installation of permanent fixtures secured about the doorframe. Thus, even when the device is removed so that a user can use the door, the fixtures remain in position on the wall and provide an undesirable appearance. Thus, a device that helps to secure a door and that can be easily installed and removed is desired.

The present invention provides a door barricade adapted for use as a home security device in order prevent an unauthorized person from opening a door to gain access to a home. The present invention provides a rigid, elongated bar disposed in a horizontal orientation so as to extend across a doorway. Each end of the elongated bar comprises an L-shaped bracket thereon having a first section to be positioned against a wall, and a second section on which an end of the elongated bar is permanently affixed. The first sections of the L-shaped brackets include apertures thereon having a circular portion and an upwardly extending channel. The apertures are adapted to receive a bolt head therethrough, and the brackets can be lowered onto the bolt so that the shaft of the bolt extends into the channel on the aperture. In this way, the bolt head, which is wider than the channel, prevents the bracket from being removed from the wall. Thus, a user can install one or more bolts on each side of the doorway, align the apertures on the brackets with the bolts, and can lower the bracket onto the bolts so as to easily install the device.

2. Description of the Prior Art

Devices have been disclosed in the prior art that relate to door barricades and home security devices. These include devices that have been patented and published in patent application publications. These devices generally relate to door barricades having an elongated bar used to maintain a door in a closed position. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 5,605,364 to Shelledy discloses a door barricade comprising an elongated bar that extends across a doorway. Mounting brackets are attached to the wall and door frame and are adapted to receive brackets disposed on the elongated bar. The device further includes a means for applying pressure to the door to restrict movement of the door within the door jamb and door frame. Thus, Shelledy disclose a door barricade having an elongated bar, but does not disclose an elongated bar having L-shaped brackets on each end, wherein said brackets include apertures thereon for removably receiving an end of a fastener, such as a bolt, disposed within a wall on opposing sides of a doorway.

U.S. Pat. No. 3,980,328 to Pearson discloses a doorbar fastened to a doorway using brackets that provide an upwardly opening pocket in which the doorbar can be inserted. The doorbar further includes a mechanism for applying force on the doorknob to prevent the doorknob from being turned. Thus, Pearson discloses a device that holds a doorknob to prevent turning thereof, and does not disclose a doorbar that includes brackets adapted to be mounted directly to a wall on opposing ends thereof.

U.S. Pat. No. 5,826,923 to Bethurem discloses a door security device comprising a crossbar to be positioned across a doorway that has a cylindrical end sleeve on each end thereof. The crossbar may be adjustable in length and includes telescoping sections. Mounting plates are disposed on opposing ends of a doorframe and have extension members for removably attaching to the cylindrical end sleeves of the crossbar. The device may be used with an existing door hinge having a hinge plate and hinge cylinder. Thus, Bethurem discloses a doorbar disposed across a doorway, but does not disclose a pair of L-shaped brackets secured on opposing ends of an elongated bar.

U.S. Pat. No. 5,899,509 to Ferguson et al. discloses a security device for securing a door. The device comprises a pair of mounting brackets to be disposed on opposite sides of a door. A bar extends between the brackets and can be configured in a securing position wherein the bar extends between the brackets, and a viewing position wherein the bar is swung away from the door such that the door may be partially opened. The device includes a viewing portion pivotally mounted to one bracket and an elongated telescoping portion pivotally mounted to the other bracket. The device of Ferguson can be arranged in multiple configurations to allow a user to partially open the door or to prevent the door from opening. In contrast, the present invention provides a rigid, elongated bar having a bracket on each end, wherein the brackets are adapted to be removably secured to a wall using a plurality of fasteners, such as bolts.

U.S. Pat. No. 4,852,921 to Gilbert et al. discloses a door security device comprising a telescoping bar having a first section and a second section wherein the bar is longer than a doorway. A door knob latching bracket is positioned on the bar for positioning the bar in an overlying relationship with the door knob. A pad is disposed on the ends of the telescoping bar and each pad is adapted to be placed in contact with the door frame to prevent the door from being opened. Thus, Gilbert discloses a door security device having a telescoping bar engaged with the edges of a doorframe, and fails to disclose a rigid, elongated bar having brackets on each end that are adapted to be removably secured to a wall on opposing sides of a doorway.

Finally, U.S. Pat. No. 7,637,130 to Carr discloses a security bar for barricading a door. The bar extends across the doorway wherein the ends of the bar engage the sides of the doorframe. The bar includes a doorknob engaging platform and a clamping member. A lock is engaged to secure the clamping member in order to prevent the bar from being removed from engagement with the doorknob. Accordingly, Carr fails to disclose a door barricade comprising an elongated bar having brackets on each end that are adapted to be mounted to a wall on opposing sides of a door.

These prior art devices have several known drawbacks. The prior art devices relate to doorbars and door barricades having various constructions. The doorbars in the prior art fail to disclose a rigid, elongated bar having L-shaped brackets permanently secured on each end thereof that can be removably engaged with fasteners mounted on the wall on opposing sides of a doorway. The present invention does not require the installation of any permanent fixtures, and simply requires the user to position one or more bolts on each side of a doorway. The brackets of the door barricade comprise apertures that can be aligned with the bolts, so as to removably position the brackets on the bolts.

In light of the devices disclosed in the prior art, it is submitted that the present invention substantially diverges in design elements from the prior art and consequently it is clear that there is a need in the art for an improvement to existing door barricade devices. In this regard the instant invention substantially fulfills these needs.

### SUMMARY OF THE INVENTION

In view of the foregoing disadvantages inherent in the known types of door barricades now present in the prior art, the present invention provides a new door barricade wherein the same can be utilized for providing convenience for the user when preventing a door on a home from opening in order to prevent intruders from gaining access to the home.

It is therefore an object of the present invention to provide a new and improved door barricade device that has all of the advantages of the prior art and none of the disadvantages.

It is another object of the present invention to provide a door barricade device that comprises an elongated, rigid bar that extends across a doorway in order to physically prevent the door from opening.

Another object of the present invention is to provide a door barricade device that comprises an elongated bar that extends across a doorway and that is mounted on opposing sides of a doorway by L-shaped brackets permanently secured on the ends thereof.

Yet another object of the present invention is to provide a door barricade device that comprises an elongated bar that can be removably positioned on one or more fasteners mounted on opposing sides of the doorway.

A further object of the present invention is to provide a door barricade device that can be removably secured across a door so as to prevent the door from opening that does not require the installation of permanent brackets or similar fixtures.

Another object of the present invention is to provide a door barricade device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the door barricade of the present invention as installed on a door.

FIG. 2 shows a cross sectional, top-down view of the door barricade of the present invention as installed on a door.

FIG. 3 shows a perspective view of the door barricade of the present invention as positioned for placement on bolts mounted on opposing sides of a doorway.

FIG. 4A shows a view of a bolt positioned within an aperture on the bracket of the present invention.

FIG. 4B shows a view of a bolt secured within a channel of an aperture on the bracket of the present invention.

### DETAILED DESCRIPTION OF THE INVENTION

Reference is made herein to the attached drawings. Like reference numerals are used throughout the drawings to depict like or similar elements of the door barricade. For the purposes of presenting a brief and clear description of the present invention, the preferred embodiment will be discussed as used for preventing a door from being opened by an unauthorized person or intruder. The figures are intended for representative purposes only and should not be considered to be limiting in any respect.

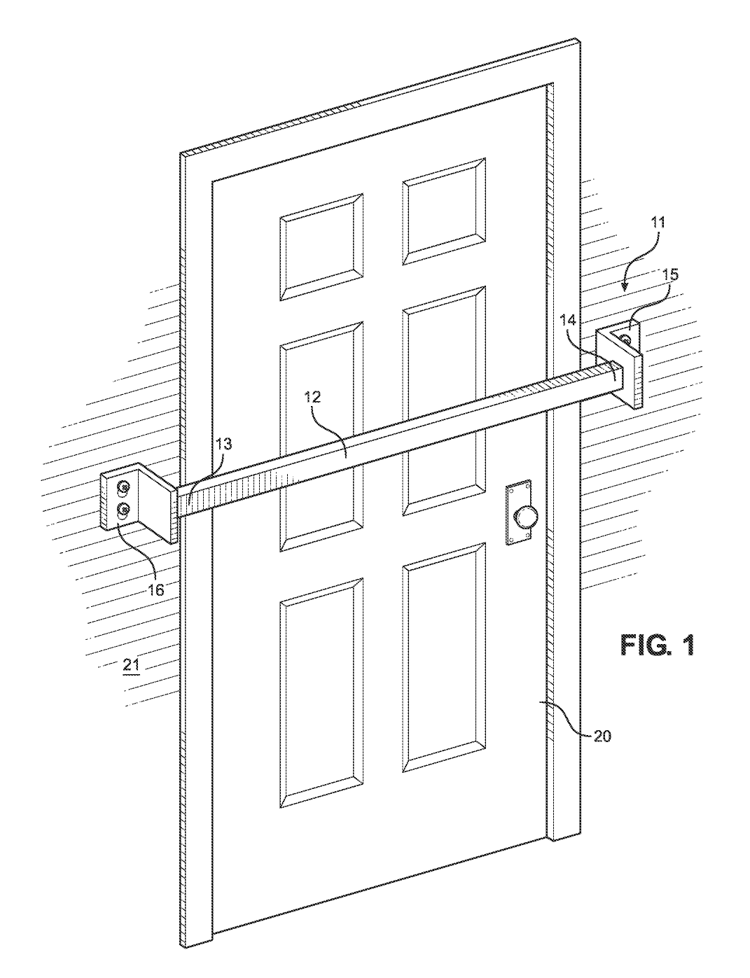

Referring now to FIG. 1, there is shown a perspective view of the door barricade of the present invention as installed on a door. The present invention provides a door barricade 11 comprising a rigid, elongated bar 12 having a first end 13 and a second end 14. The elongated bar 12 may be cylindrical in shape or may have any of a variety of cross sections, such as a triangular or square shaped cross section. The elongated bar 12 is preferably composed of stainless steel, fiberglass, or another strong, durable material. The elongated bar 12 is adapted to be disposed in a horizontal orientation such that it extends across a door 20 so as to prevent the inward rotation of the door 20. Thus, the elongated bar 12 physically prevents the door 20 from opening as the elongated bar 12 is positioned so as to impede the movement of the door 20. In this way, the elongated bar 12 prevents the door from opening regardless of whether the door has been locked.

The first end 13 of the elongated bar 12 includes a first bracket 16 thereon, and the second end 14 of the elongated bar 12 includes a second bracket 15 thereon. The first and second brackets 16, 15 are L-shaped, such that a first section of each bracket is positioned flush against a wall, and a second section of each bracket extends outward therefrom. The elongated bar 12 is secured to the second section of each the first and second brackets 16, 15. The first and second brackets 16, 15 are substantially mirror images of one another. Preferably, the first and second brackets 16, 15 are permanently affixed to the elongated bar 12, such that the door barricade 11 is of unitary construction.

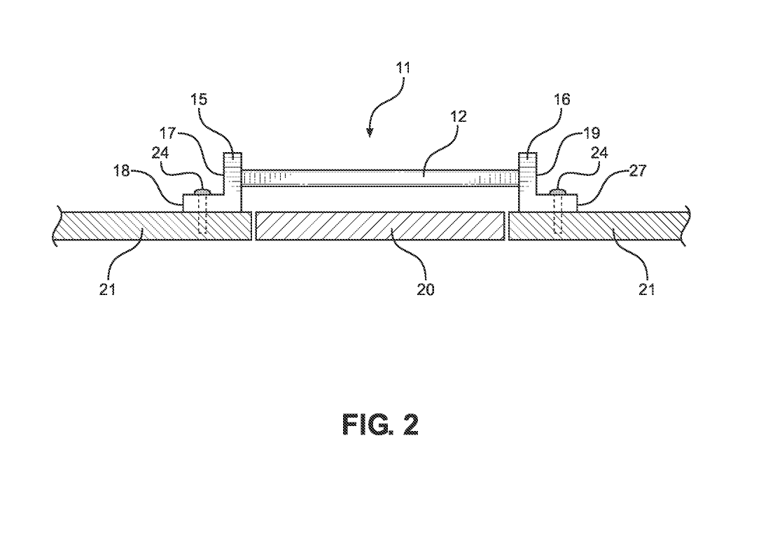

Referring now to FIG. 2, there is shown a cross sectional, top-down view of the door barricade of the present invention as installed on a door. The first bracket 16 comprises a first section 27 perpendicular to a second section 19. Similarly, the second bracket 15 comprises a first section 18 perpendicular to a second section 17. The first sections 27, 18 of the brackets 16, 15 include apertures thereon and the first sections 27, 18 are adapted to be positioned against a wall 21 or door frame. The apertures can be aligned with bolts 24 mounted on the wall 21 and the brackets 16, 15 can be placed onto the bolts 24. Thus, the bolts 24 do not permanently affix the brackets 16, 15 to the wall 21, and a user may simply place the brackets 16, 15 onto the bolts 24 and remove the brackets 16, 15 therefrom as desired without the use of tools or other fasteners.

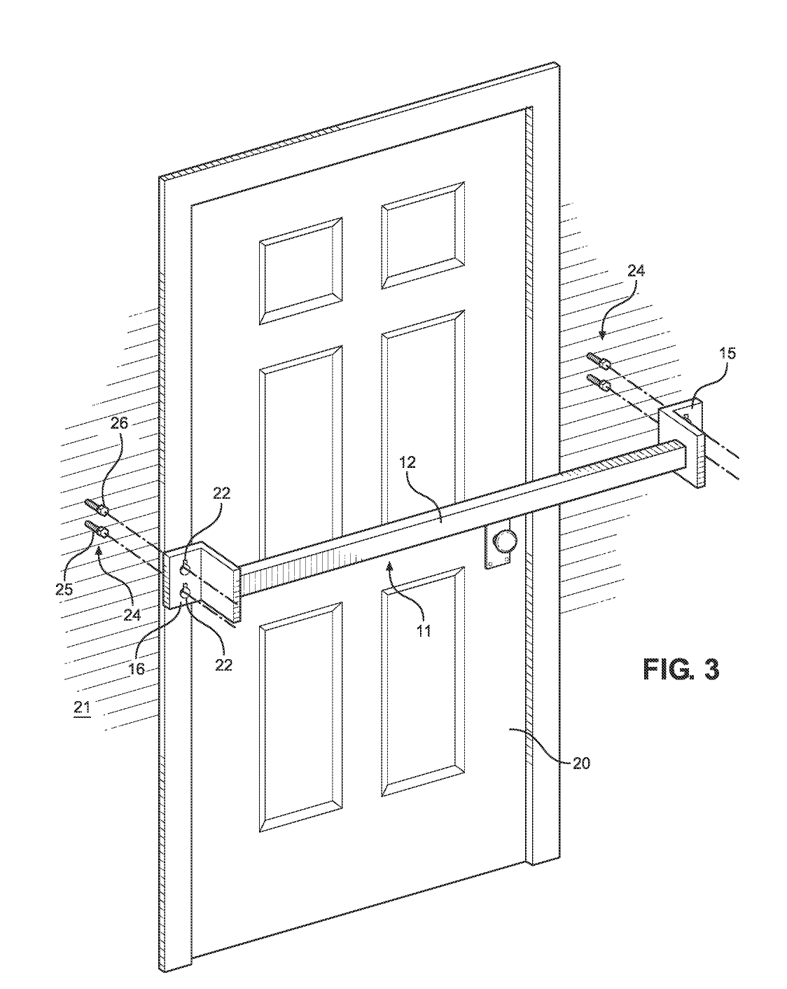

Referring now to FIG. 3, there is shown a perspective view of the door barricade of the present invention as positioned for placement on bolts mounted on the wall on opposing sides of a doorway. In operation, a user can mount bolts 24 on opposing sides of a doorway. The bolts 24 are inserted into the wall 21 on opposing sides of the doorway such that a portion of the shaft 25 of the bolt 24 extends outward from the wall 21. Thus, the bolt head 26 is not flush against the wall 21.

Once the bolts 24 are mounted on the walls 21 on opposing sides of a door 20, the door barricade 11 of the present invention can be removably placed onto the bolts 24 by aligning the apertures 22 on the first and second brackets 16, 15 with the bolts 24. The door barricade 11 is placed on the bolts 24 such that the brackets 16, 15 are supported thereon and are flush against the wall 21. In this way, the elongated bar 12 is brought in close proximity to the door 20 so that the door 20 is completely or substantially prevented from inward rotation. When installed, the elongated bar 12 may be spaced slightly from the door 20.

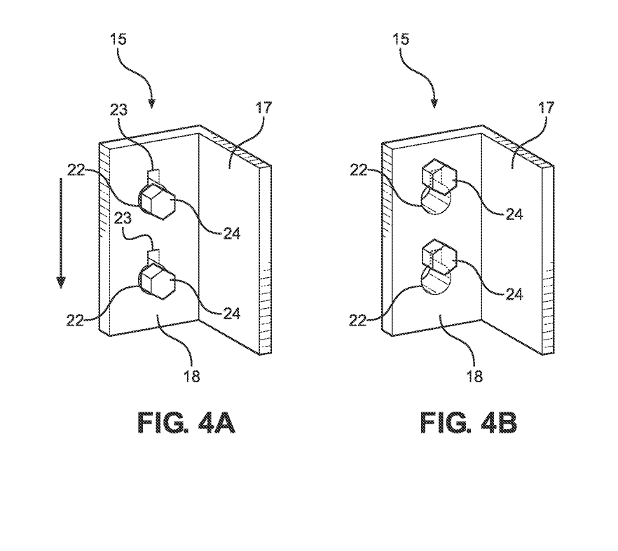

Referring now to FIGS. 4A and 4B, there are shown views of a bracket of the present invention as positioned for installation. It is contemplated that the first bracket is substantially a mirror image of the second bracket 15 such that the first bracket contains all of the elements of the second bracket 15 included herein. The first section 18 of bracket 15 of the door barricade includes apertures 22 thereon having a circular central portion and a narrow channel on an upper end 23 thereof. Each bracket can be positioned so as to align the circular central portion with the bolt heads mounted in the walls. The bolt heads can be inserted through the apertures 22 so that the first section 18 of the bracket 15 is flush against a wall and the second section 17 of the bracket 15 extends outward therefrom. The door barricade can then be lowered vertically downwards so that the shaft of the bolt 24 is positioned within the narrow channel, as shown in FIG. 4B. In this way, the brackets 15 are removably secured on the bolts 24. If the door were to be opened, the brackets would be restrained by the bolt heads, which are wider than the narrow channels 23, preventing the brackets from falling off of the bolts 24.

Thus, a user can easily install the door barricade by positioning the door barricade on bolts that are preinstalled on opposing sides of the door. To remove the barricade, the user can easily lift the door barricade vertically upwards so that the bolt heads are aligned with the circular central portion of the apertures. The user can then remove the door barricade from the bolts. In this way, when the door barricade is removed, all that remains are the bolts on opposing sides of the doorway. Thus, no brackets or fixtures remain on opposing sides of the doorway.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A door barricade, comprising:
an elongated bar having a first end and a second end adapted to be disposed horizontally across a door frame so as to prevent a door from opening;
a first L-shaped bracket having a first section and a second section, wherein said second section is secured to said first end of said elongated bar, and wherein said first section is adapted to be positioned flush against a wall;
a second L-shaped bracket having a first section and a second section, wherein said second section is secured to said second end of said elongated bar, and wherein said first section is adapted to be positioned flush against said wall;
wherein said first section of said first L-shaped bracket comprises at least one aperture;
wherein said first section of said second L-shaped bracket comprises at least one aperture;
wherein said at least one aperture of said first L-shaped bracket and said at least one aperture of said second L-shaped bracket is adapted to receive a fastener therethrough.

2. The door barricade of claim 1, wherein said elongated bar has a substantially rectangular cross section.

3. The door barricade of claim 1, wherein said at least one aperture on said first L-shaped bracket are vertically aligned, and wherein said at least one aperture on said second L-shaped bracket are vertically aligned.

4. The door barricade of claim 1, wherein said first L-shaped bracket is permanently secured to said first end of said elongated bar, and wherein said second L-shaped bracket is permanently secured to said second end of said elongated bar.

5. The door barricade of claim 1, wherein
said at least one aperture on said first section of said first L-shaped bracket is circular and further comprises a channel on an upper end thereof;
said at least one aperture on said first section of said second L-shaped bracket is circular and further comprises a channel on an upper end thereof.

6. The door barricade of claim 5, wherein said fastener comprises a bolt having a shaft and a bolt head;
wherein a plurality of said fasteners are adapted to be installed on opposing sides of a doorway such that a portion of said shaft of said fasteners extends outward from said wall;
wherein said at least one aperture on said first L-shaped bracket and said at least one aperture on said second L-shaped bracket are adapted to be aligned with said bolts on opposing sides of said doorway;
wherein said channel of said at least one aperture is adapted to receive said shaft of said bolt so as to removably secure said first L-shaped bracket and said second L-shaped bracket thereon.

7. The door barricade of claim 5, wherein
said fastener comprises a bolt having a shaft and a bolt head;
wherein said bolt head is sized so as to be unable to pass through said channel on said aperture on said first L-shaped bracket and on said second L-shaped bracket.
